(19) United States
(12) Patent Application Publication
(10) Pub. No.: US 2023/0314011 A1
(43) Pub. Date: Oct. 5, 2023

(54) LUMINAIRE CHILLED BEAM

(71) Applicant: Price Industries, Inc., Suwanee, GA (US)

(72) Inventors: Kyu Hwang, Alpharetta, GA (US); Nathan Vaughn, Lawrenceville, GA (US); Chris Burroughs, Braselton, GA (US); Danyang Yu, Suwanee, GA (US)

(21) Appl. No.: 18/129,186

(22) Filed: Mar. 31, 2023

Related U.S. Application Data
(60) Provisional application No. 63/326,300, filed on Apr. 1, 2022.

(51) Int. Cl. F24F 1/0047; F21V 33/00; F24F 1/01

(52) U.S. Cl. CPC F24F 1/0047; F21V 33/0092; F24F 1/01; F21V 21/03

(57) ABSTRACT

Disclosed herein is a luminaire chilled beam that can incorporate lighting into a chilled beam unit without affecting the capacity, performance, or dimensions of the chilled beam. The luminaire chilled beam can include a pressure chamber configured to receive primary air through a primary air inlet. A nozzle plate in a lower portion of the pressure chamber can allow the primary air to be expelled from the pressure chamber and thereby cause an induction of air from an external setting through an induction face and into an induction chamber. A water coil can be configured to treat the induced air within the induction chamber. The induced air and the primary air can be expelled from the induction chamber and into the setting through discharge channels. The luminaire chilled beam can further include a luminaire assembly including a luminaire positioned between the induction face and the discharge channel at the lower portion of the induction chamber, the luminaire configured to illuminate the external setting.

### CROSS-REFERENCE TO RELATED APPLICATIONS

This application claims benefit of and priority to co-pending U.S. Provisional App. No. 63/326,300, filed on Apr. 1, 2022 and entitled “LUMINAIRE CHILLED BEAM,” which is incorporated by reference herein in its entirety.

### BACKGROUND

Chilled beams may be installed in ceilings of indoor environments to provide heated or cooled air to those environments. However, chilled beams may be unable to be incorporated in some environments where ceiling space is reserved for lighting. When incorporating lighting into chilled beam units, though, the lighting often obstructs air flow within the chilled beam, leading to degraded performance and capacity. These integrated units are also often of a different size and aesthetic appearance than chilled-beam-only units such that they cannot be seamlessly incorporated into existing environments.

### BRIEF DESCRIPTION OF THE DRAWINGS

For a more complete understanding of the embodiments and the advantages thereof, reference is now made to the following description, in conjunction with the accompanying figures briefly described as follows:

FIGS. 1A-1B illustrate examples of front perspective views of a luminaire chilled beam, according to various embodiments of the present disclosure.

FIGS. 2A-2C illustrate examples of front views of the luminaire chilled beam, according to various embodiments of the present disclosure.

FIGS. 3A-3C illustrate examples of rear views of the luminaire chilled beam, according to various embodiments of the present disclosure.

FIGS. 4A-4D illustrate examples of top views of the luminaire chilled beam, according to various embodiments of the present disclosure.

FIGS. 5A-5B illustrate examples of bottom views of the luminaire chilled beam, according to various embodiments of the present disclosure.

FIGS. 6A-6C illustrate examples of first side views of the luminaire chilled beam, according to various embodiments of the present disclosure.

FIGS. 7A-7C illustrate examples of second side views of the luminaire chilled beam, according to various embodiments of the present disclosure.

FIG. 8 illustrates an example of an isolated perspective view of a control module of the luminaire chilled beam, according to various embodiments of the present disclosure.

### DETAILED DESCRIPTION

Disclosed herein is a luminaire chilled beam that can incorporate lighting into a chilled beam unit without affecting the capacity, performance, or dimensions of the chilled beam. Unlike conventional units, the luminaire chilled beam can integrate a luminaire with a chilled beam in a single unit with a same profile as a chilled-beam-only unit. The luminaire chilled beam can be constructed so that all its components fit within a standard cell of a suspension grid drop ceiling. Likewise, the luminaire chilled beam can be constructed so that it fits universally in existing buildings with different ceiling heights. In addition, the luminaire chilled beam can receive seismic certification as a single unit.

In some examples, multiple luminaire chilled beams can be connected together in parallel or in series. Connecting the multiple luminaire chilled beams can allow them to operate together while giving the aesthetic appearance of a single, integrated unit.

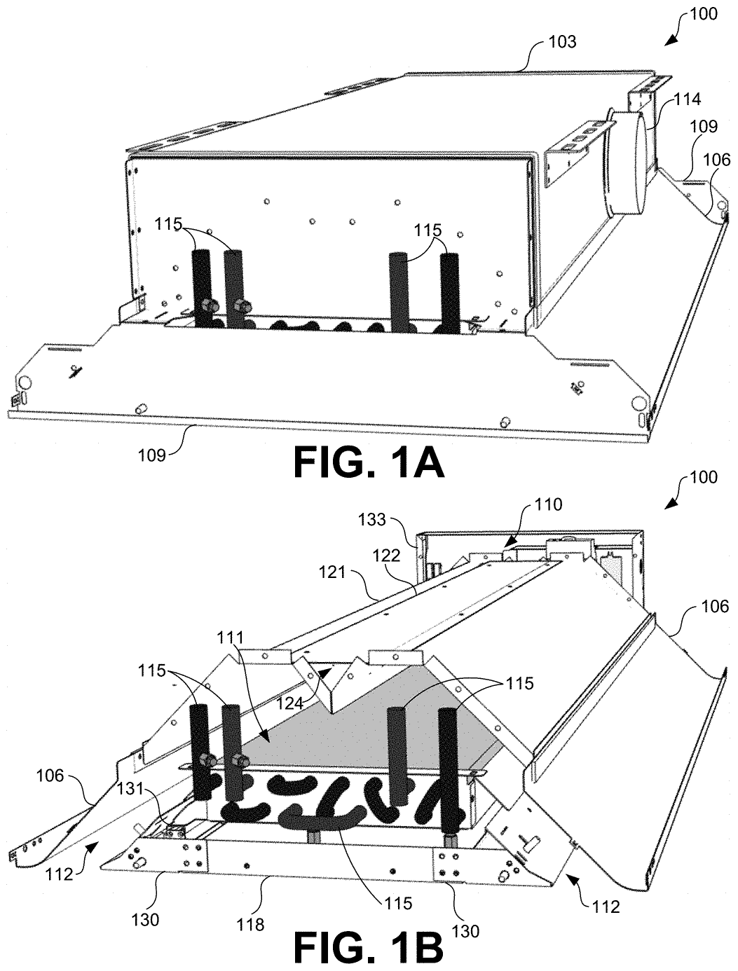

FIGS. 1A-1B illustrate examples of front perspective views of a luminaire chilled beam 100. FIG. 1A shows an outside of the luminaire chilled beam 100, while FIG. 1B shows various external and internal components of the luminaire chilled beam 100. An exterior of the luminaire chilled beam 100 can include an outer housing 103, exit casings 106, and exit casing end caps 109.

A lower portion of the luminaire chilled beam 100 can include an induction chamber 111 enclosed at least in part within the exit casings 106 and exit casing end caps 109. The exit casings 106 can be affixed to a bottom portion of either side of the outer housing 103 and to exit casing end caps 109, as well as to a nozzle plate 121 discussed in more detail below. The exit casings 106 can form outer sides of a discharge channel 112 on either side of the induction chamber 111. An upper portion of the luminaire chilled beam 100 can include a pressurization chamber 110 enclosed at least in part within the outer housing 103.

The outer housing 103 can enclose various internal components of the luminaire chilled beam 100. The outer casing can include a primary air inlet 114 that can connect to ductwork through which an upstream air supply system can supply primary air to the luminaire chilled beam 100. In some examples, the outer housing 103 can be made from galvanneal steel that can resist corrosion and damage.

The pressurization chamber 110 can be a space within the luminaire chilled beam 100 that functions as a plenum. Upper and lateral boundaries of the pressurization chamber can be defined by the outer housing 103, and a lower boundary of the pressurization chamber 110 can be defined by a nozzle plate 121. Primary air can be supplied to the pressurization chamber 110 through the primary air inlet 114. The outer housing 103 and the nozzle plate 121 can together create a seal within the pressurization chamber 110. Thus, the primary air flowing into the pressurization chamber 110 can create a high-pressure environment within the pressurization chamber 110. The elevated pressure created in the pressurization chamber 110 can cause the primary air to be expelled at a high velocity from a plurality of nozzles 124 comprising small apertures in a portion of the nozzle plate 121. In addition, a perforated baffle 122 can be attached to a central portion of the nozzle plate above the nozzles 124. The perforated baffle 122 can include a plurality of perforations through which the primary air can pass before being expelled from the nozzles 124, causing the primary air to be evenly distributed to the nozzles 124.

The induction chamber 111 can be a space within the luminaire chilled beam 100 into which air from an external setting can be induced and treated. A lower boundary of the induction chamber 111 can be defined by an induction face 118, while an upper boundary of the induction chamber 111 can be defined by the nozzle plate 121. Lateral boundaries of the induction chamber 111 can be defined by the discharge channels 112. Primary air expelled at a high velocity from the nozzles 124 into the discharge channel 112 can create a low-pressure environment within the induction chamber 111. This low pressure can induce air from the external setting to flow upwards through the induction face 118, be cooled or heated by a water coil 115, and flow into the discharge channel 112. The induced air can mix with the expelled primary air in the discharge channel 112.

The water coil 115 can treat air within the induction chamber 111 by heating or cooling the air with heated or cooled water running through the water coil 115. The water coil 115 can connect to an external water source through one or more inlets that protrude from the induction chamber 111.

Induction face 118 can be a permeable cover attached to a bottom opening of the induction chamber 111. The induction face 118 can face into an external setting in which the luminaire chilled beam 100 is installed. Induced air from the external setting can pass through the induction face 118 and into the induction chamber 111. A portion of the induction face 118 through which air can pass can include a grille, perforations, louver, or other configuration. The induction face 118 can be contained within a frame attached at either side to a pair of luminaire assemblies 130, discussed in more detail below.

The induction face 118 can swing open at one or both sides using a pin latch to provide access to internal components of the luminaire chilled beam 100 for maintenance, such as replacement of luminaires 131 within the luminaire assemblies 130. In some examples, the induction face 118 may open only from a single side to prevent the induction face 118 from falling down freely, which could damage internal components of the luminaire chilled beam 100. In some examples, the induction face 118 can open without the use of tools by pushing a handle on a pin latch.

The discharge channels 112 can be spaces within the luminaire chilled beam 100 through which air within the induction chamber 111 can be discharged from the luminaire chilled beam 100 and into an external setting. Lateral boundaries of each of the discharge channels 112 can be defined by a side flange of nozzle plate 121 and a side flange of water coil 115, an exit casing 106, a luminaire assembly 130. The primary air combined with the induced air, which can be cooled or heated by the water coil 115, can be discharged from the luminaire chilled beam 100 through the discharge channels 112 and into the external setting.

Luminaire assemblies 130 can include luminaires 131 that illuminate an external setting in which the luminaire chilled beam 100 is installed without affecting air treatment performance or the capacity of the luminaire chilled beam 100. The frame of each luminaire assembly 130 can present a smooth surface that does not obstruct air flow through the discharge channel 112. Each of the luminaires 131 can comprise a lamp that is held within a frame of its luminaire assembly 130 attached at one side to the induction face 118. Each luminaire 131 can include a lamp such as, for example, an incandescent lamp, a fluorescent lamp, a light-emitting diode (LED) lamp, or other light source. The luminaires 131 can be detached from their luminaire assemblies 130 and replaced with new luminaires 131. While a heat emitted by each luminaire 131 may undesirably add heat load to a proximity of the luminaire assembly 130, that heated air can be induced into the induction chamber 111 and treated along with other air induced from the external setting.

The control module 133 can include various components used to control operation of the luminaire chilled beam 100 and the luminaires 131 in particular. For example, the control module 133 can activate and deactivate the luminaires 131, adjust a brightness of light emitted by the luminaires 131, or adjust a color temperature of light emitted by the luminaires 131. The control module 133 can be secured to an outer surface of the outer housing 103. In some implementations, however, the control module 133 can be installed remotely from the other components of the luminaire chilled beam 100.

In some examples, a luminaire chilled beam 100 can be controlled by its own control module 133. In other examples, a single control module 133 may be used to control operation of multiple luminaire chilled beams 100. This single control module 133 can be attached to or proximate to one of the multiple luminaire chilled beams 100 or located in a location remote from the multiple luminaire chilled beams 100.

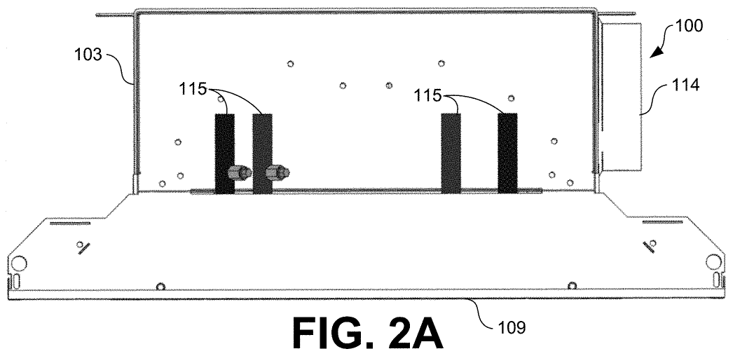

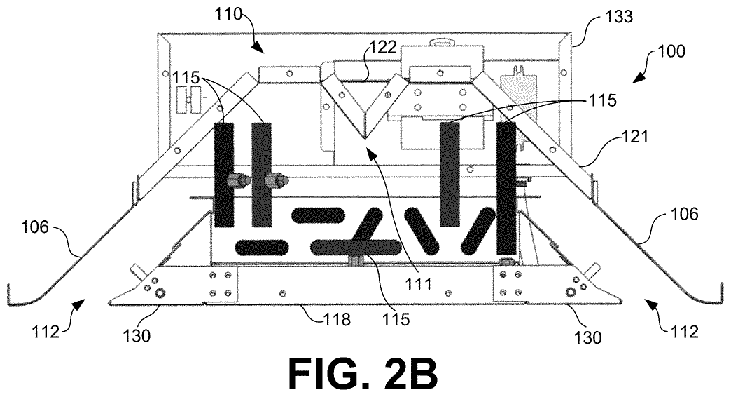

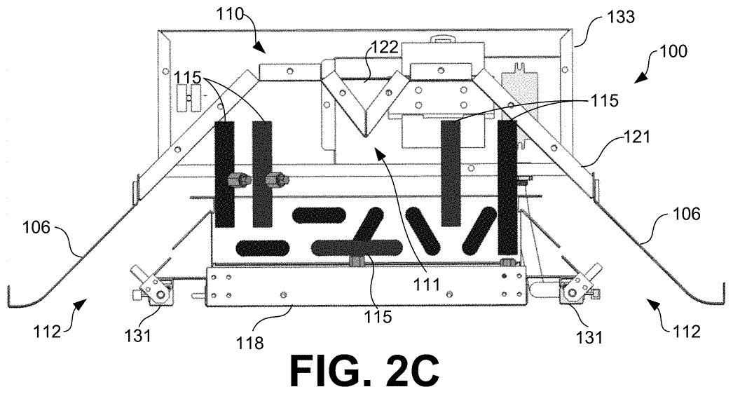

FIGS. 2A-2C illustrate examples of front views of the luminaire chilled beam 100. FIG. 2A shows an outside of the luminaire chilled beam 100 from a front view, including portions of the outer housing 103, the exit casing end caps 109, the primary air inlet 114, and water coil 115. FIG. 2B shows various external and internal components of the luminaire chilled beam 100 from a front view, with the outer housing 103, the exit casing end caps 109, and primary air inlet 114 not shown. The components shown in FIG. 2B include portions of the exit casings 106, pressurization chamber 106, induction chamber 111, discharge channels 112, water coil 115, induction face 118, nozzle plate 121, perforated baffle 122, luminaire assemblies 130, and control module 133. FIG. 2B shows various external and internal components of the luminaire chilled beam 100 from a front view, with the outer housing 103, the exit casing end caps 109, primary air inlet 114, and luminaire assemblies 130 not shown. The components shown in FIG. 2B include portions of the exit casings 106, pressurization chamber 106, induction chamber 111, discharge channels 112, water coil 115, induction face 118, nozzle plate 121, perforated baffle 122, luminaires 131, and control module 133

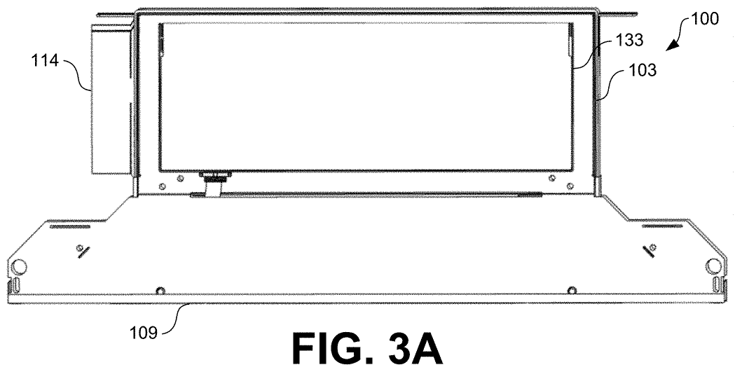

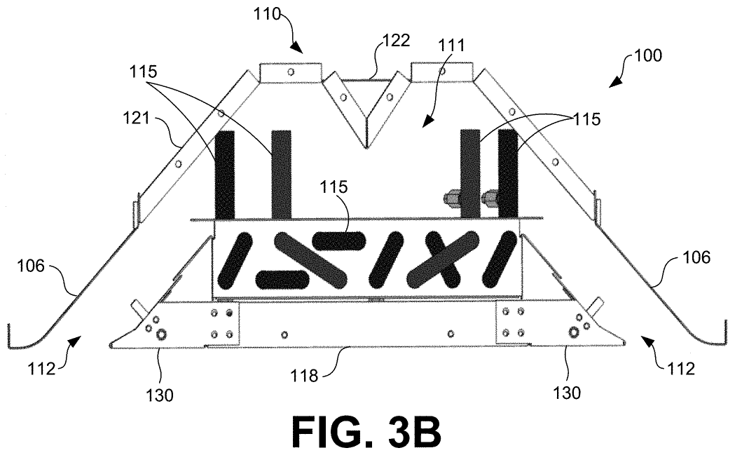

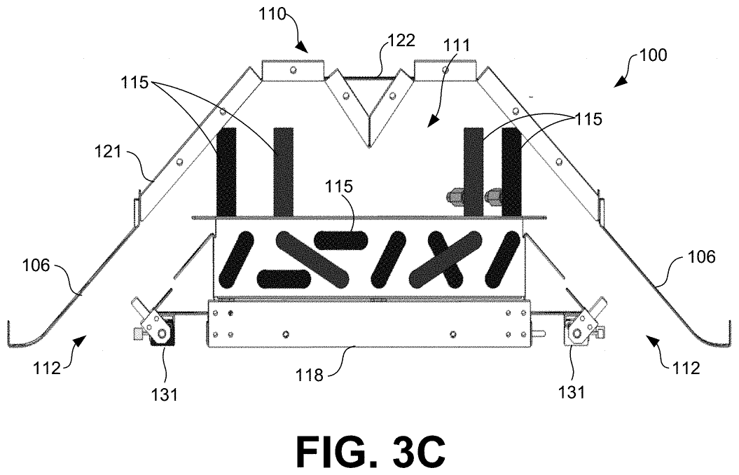

FIGS. 3A-3C illustrate examples of rear views of the luminaire chilled beam 100. FIG. 3A shows an outside of the luminaire chilled beam from a rear view, including portions of the outer housing 103, exit casing end caps 109, primary air inlet 114, and control module 133. FIG. 3B shows various external and internal components of the luminaire chilled beam 100 from a rear view, with the outer housing 103, exit casing end caps 109, primary air inlet 114, and control module 133 not shown. The components shown in FIG. 3B include portions of the exit casings 106, pressurization chamber 110, induction chamber 111, discharge channels 112, water coil 115, induction face 118, nozzle plate 121, perforated baffle 122, and luminaire assemblies 130. FIG. 3C shows various external and internal components of the luminaire chilled beam 100 from a rear view, with the outer housing 103, exit casing end caps 109, primary air inlet 114, luminaire assemblies 130, and control module 133 not shown. The components shown in FIG. 3C include portions of the exit casings 106, pressurization chamber 110, induction chamber 111, discharge channels 112, water coil 115, induction face 118, nozzle plate 121, perforated baffle 122, and luminaires 131.

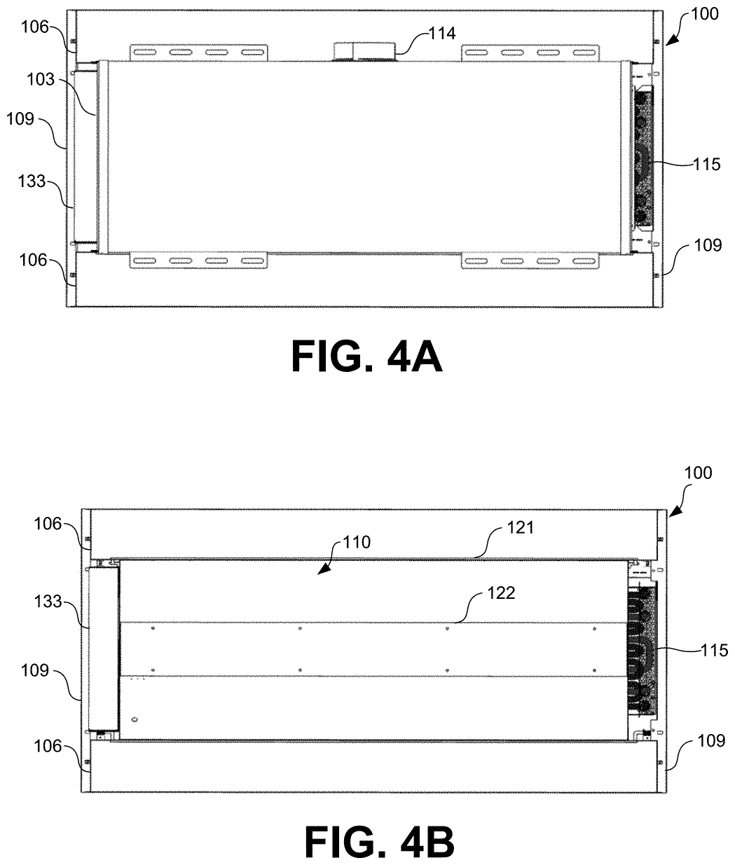

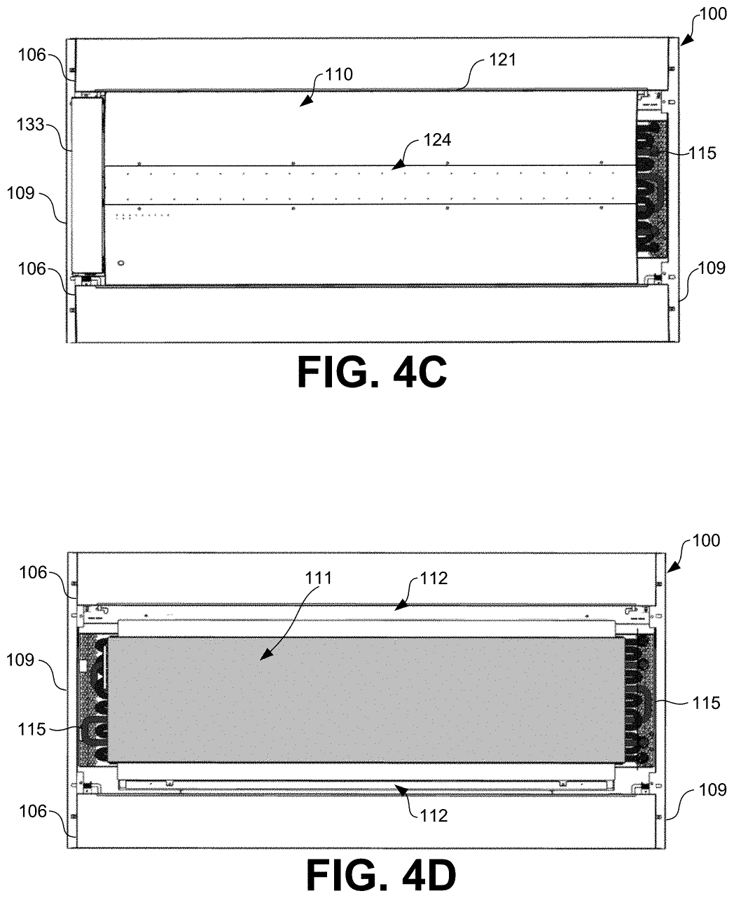

FIGS. 4A-4D illustrate examples of top views of the luminaire chilled beam 100. FIG. 4A shows an outside of the luminaire chilled beam 100 from a top view, including portions of the outer housing 103, exit casings 106, exit casing end caps 109, primary air inlet 114, water coil 115, and control module 133. FIG. 4B shows various external and internal components the luminaire chilled beam 100 from a top view, with the outer housing 103 and the primary air inlet 114 not shown. The components shown in FIG. 4B include portions of the exit casings 106, exit casing end caps 109, pressurization chamber 110, water coil 115, nozzle plate 121, perforated baffle 122, and control module 133. FIG. 4C shows various external and internal components the luminaire chilled beam 100 from a top view, with the outer housing 103, the primary air inlet 114, and the perforated baffle 122 not shown. The components shown in FIG. 4C include portions of the exit casings 106, exit casing end caps 109, pressurization chamber 110, water coil 115, nozzle plate 121, nozzles 124, and control module 133. FIG. 4D shows various external and internal components the luminaire chilled beam 100 from a top view, with the outer housing 103, the primary air inlet 114, the nozzle plate 121, the perforated baffle 122, and the control module 133 not shown. The components shown in FIG. 4D include portions of the exit casing 106, exit casing end caps 109, induction chamber 111, discharge channels 112, and water coil 115.

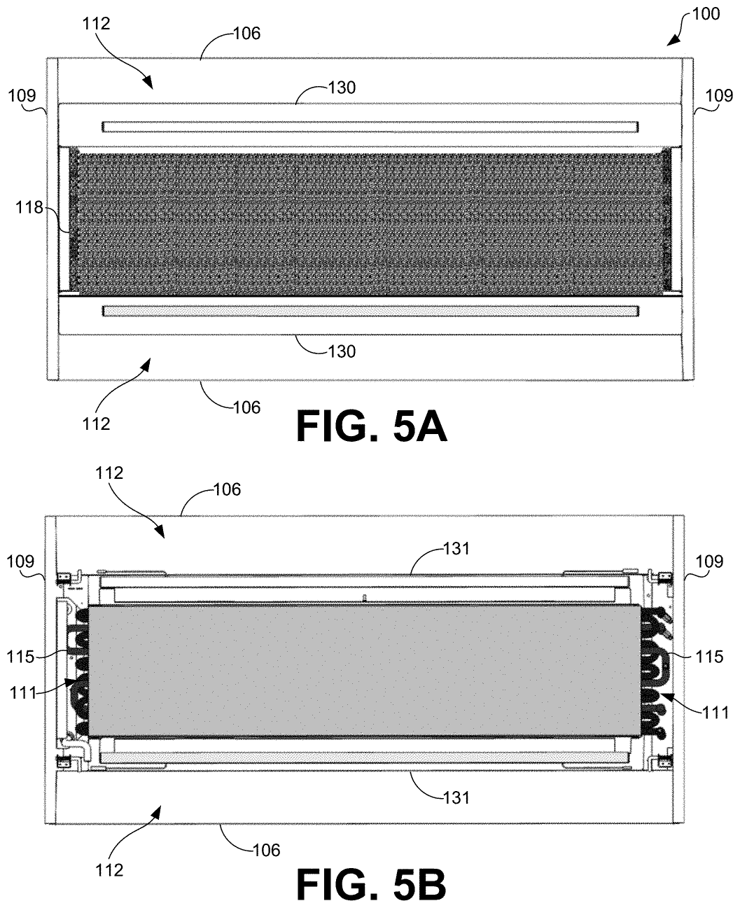

FIGS. 5A-5B illustrate examples of bottom views of the luminaire chilled beam 100. FIG. 5A shows an outside of the luminaire chilled beam 100 from a bottom view, including portions of exit casings 106, exit casing end caps 109, discharge channels 112, induction face 118, and luminaire assemblies 130. FIG. 5B shows various external and internal components of the luminaire chilled beam 100 from a bottom view, with the induction face 118, and luminaire assemblies 130 not shown. The components shown in FIG. 5B include portions of the exit casings 106, exit casing end caps 109, induction chamber 111, discharge channels 112, water coil 115, and luminaires 131.

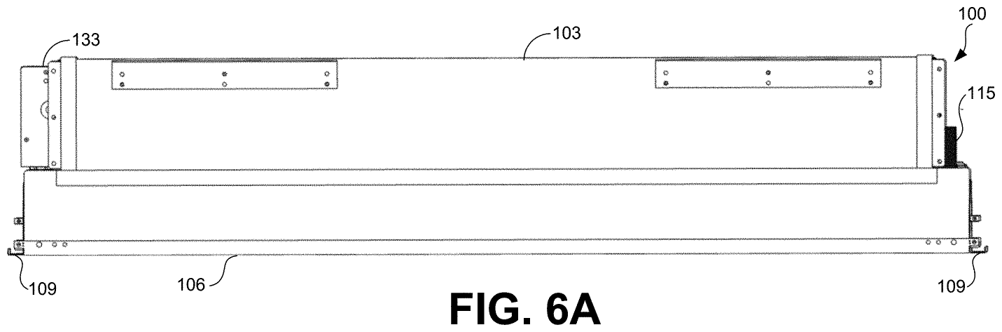

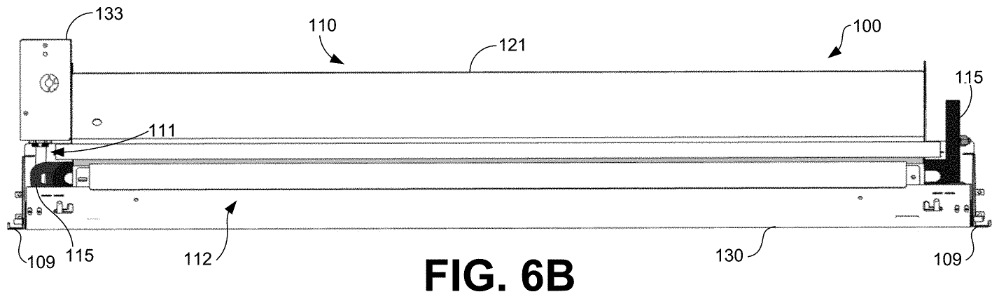

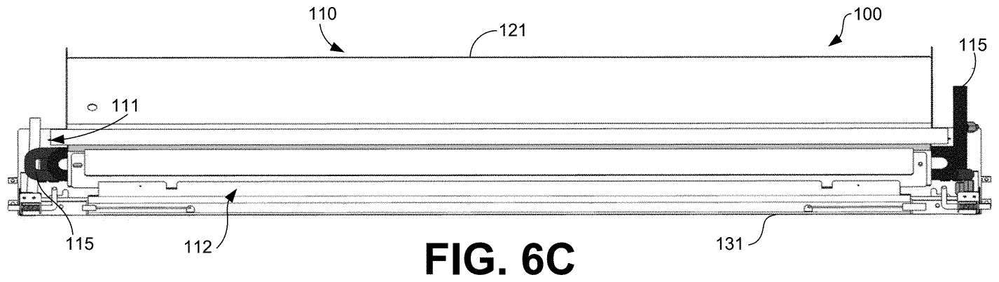

FIGS. 6A-6C illustrate examples of first side views of the luminaire chilled beam 100. FIG. 6A shows an outside of the luminaire chilled beam 100 from a first side view, including portions of the outer housing 103, exit casings 106, exit casing end caps 109, water coil 115, and control module 133. FIG. 6B shows various external and internal components of the luminaire chilled beam 100 from a first side view, with the outer housing 103, exit casings 106, and primary air inlet 114 not shown. The components shown in FIG. 6B include portions of the exit casing end caps 109, the pressurization chamber 110, induction chamber 111, discharge channel 112, water coil 115, nozzle plate 121, luminaire assembly 130, and control module 133. FIG. 6C shows various external and internal components of the luminaire chilled beam 100 from a first side view, with the outer housing 103, exit casings 106, exit casing end caps 109, primary air inlet 114, luminaire assembly 130, and control module 133 not shown. The components shown in FIG. 6C include portions of the pressurization chamber 110, induction chamber 111, discharge channel 112, water coil 115, nozzle plate 121, and luminaire 131.

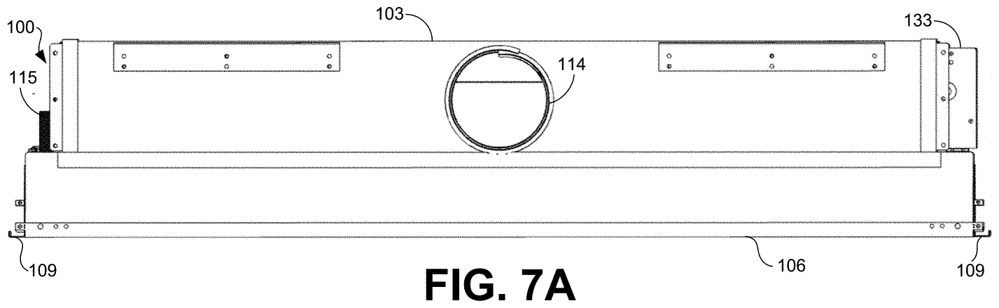

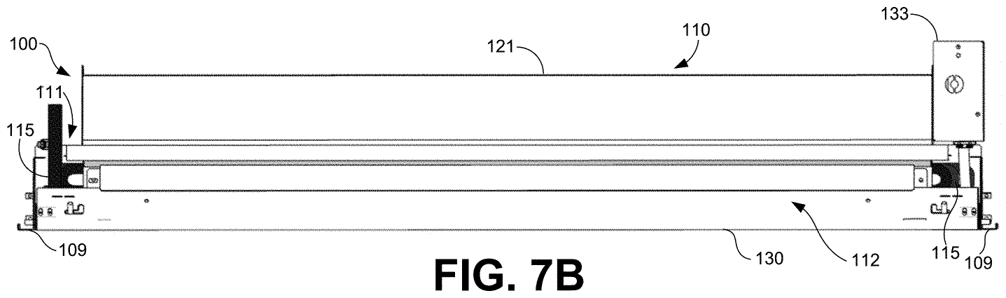

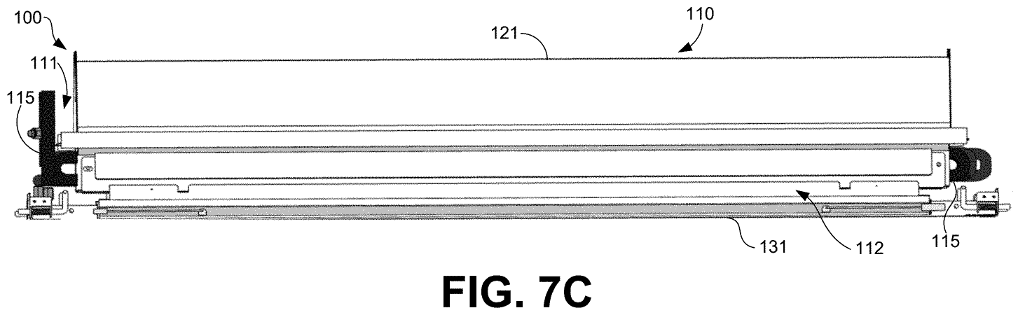

FIGS. 7A-7C illustrate examples of second side views of the luminaire chilled beam 100. FIG. 7A shows an outside of the luminaire chilled beam 100 from a second side view, including portions of the outer housing 103, exit casings 106, exit casing end caps 109, primary air inlet 114, water coil 115, and control module 133. FIG. 7B shows various external and internal components of the luminaire chilled beam 100 from a second side view, with the outer housing 103, exit casings 106, and primary air inlet 114 not shown. The components shown in FIG. 7B include portions of the pressurization chamber 110, induction chamber 111, discharge channels 112, water coils 115, nozzle plate 121, and luminaire 130. FIG. 7C shows various external and internal components of the luminaire chilled beam 100 from a second side view, with the outer housing 103, exit casings 106, and primary air inlet 114 not shown. The components shown in FIG. 7C include portions of the pressurization chamber 110, induction chamber 111, discharge channels 112, water coils 115, nozzle plate 121, and luminaire 131.

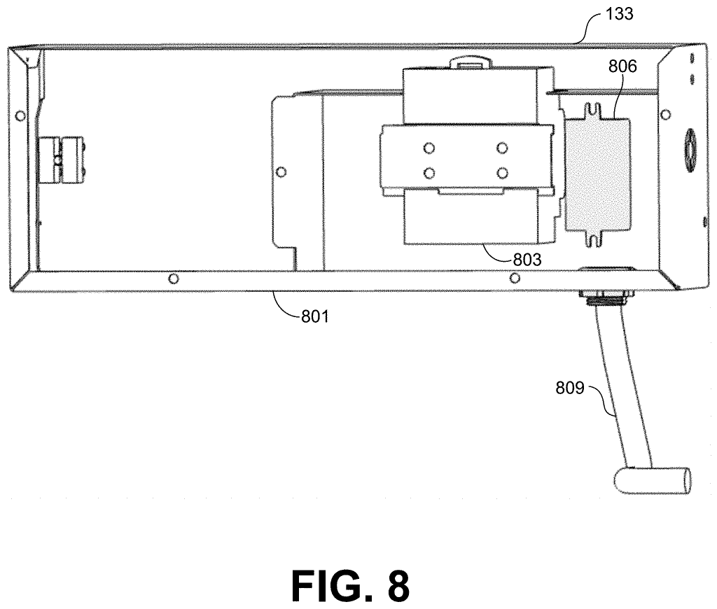

FIG. 8 illustrates an example of an isolated perspective view of a control module 133 of the luminaire chilled beam 100. The control module 133 can include an enclosure 801, a driver 803, a wireless controller 806, and a conduit 809. The enclosure 801 can enclose the driver 803, wireless controller 806, and conduit 809 and protect them from external environments. The driver 803 and the wireless controller 806 can be secured to the outer housing 103. The driver 803 can be any device capable of regulating power supplied to the luminaires 130, such as, for example, a driver, a ballast, or a transformer. The wireless controller 806 can facilitate remote control of the luminaires 130 by a remote computing device. The wireless controller 806 can be any microcontroller, circuit board, or other electronic device capable of wirelessly connecting to a computing device to control the luminaires 130. The conduit 809 can connect the driver 803 and/or the wireless controller 806 to one or multiple luminaires 130 to supply power. In examples where the conduit 809 connects to only one of the luminaires 130, the luminaire 130 to which the conduit 809 connects can itself be connected to other luminaire 130.

A phrase, such as “at least one of X, Y, or Z,” unless specifically stated otherwise, is to be understood with the context as used in general to present that an item, term, etc., can be either X, Y, or Z, or any combination thereof (e.g., X, Y, and/or Z). Similarly, “at least one of X, Y, and Z,” unless specifically stated otherwise, is to be understood to present that an item, term, etc., can be either X, Y, and Z, or any combination thereof (e.g., X, Y, and/or Z). Thus, as used herein, such phrases are not generally intended to, and should not, imply that certain embodiments require at least one of either X, Y, or Z to be present, but not, for example, one X and one Y. Further, such phrases should not imply that certain embodiments require each of at least one of X, at least one of Y, and at least one of Z to be present.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present disclosure defined in the following claims, the scope of which are to be accorded the broadest interpretation so as to encompass modifications and equivalent structures.

Therefore, at least the following is claimed:

1. A luminaire chilled beam, comprising:
a pressure chamber configured to receive primary air from an upstream air supply system through a primary air inlet;
an induction chamber adjacent to the pressure chamber comprising an induction face at a lower portion of the induction chamber;
a nozzle plate affixed to an underside of the pressure chamber and configured to expel the supplied air from the pressure chamber and thereby cause an induction of air from an external setting into the induction chamber through the induction face;
a water coil configured to treat the induced air within the induction chamber;
a discharge channel configured to expel the induced air and the primary air from the induction chamber and into the external setting; and
a luminaire assembly positioned between the induction face and the discharge channel at the lower portion of the induction chamber, the luminaire assembly comprising a luminaire configured to illuminate the external setting.

2. The luminaire chilled beam of claim 1, wherein the induction face comprises a grille, a plurality of perforations, or a plurality of louvers.

3. The luminaire chilled beam of claim 1, wherein treating the primary air and the induced air comprises cooling or heating the primary air and the induced air.

4. The luminaire chilled beam of claim 1, wherein the water coil is further configured to treat induced air that is undesirably heated by the luminaire.

5. The luminaire chilled beam of claim 1, further comprising a control module configured to control an operation of the luminaire.

6. The luminaire chilled beam of claim 5, wherein the control module is configured to wirelessly control the operation of the luminaire.

7. The luminaire chilled beam of claim 1, wherein the luminaire assembly comprises a frame to which the luminaire is detachably attached, and the luminaire comprises an incandescent lamp, a fluorescent lamp, or a light-emitting diode lamp.

8. The luminaire chilled beam of claim 1, wherein the luminaire chilled beam is installed in a ceiling of the external setting, and the luminaire chilled beam occupies less space within the ceiling than a separate luminaire and a separate chilled beam installed in the ceiling.

9. The luminaire chilled beam of claim 1, wherein the luminaire chilled beam is connected in parallel or in series to a plurality of other luminaire chilled beams, the luminaire chilled beam and the plurality of other luminaire chilled beams operating as a single unit.

10. The luminaire chilled beam of claim 1, wherein the induction face comprises a pin latch configured to provide toolless access to internal components of the luminaire chilled beam from the external setting.

11. An apparatus, comprising:
a housing;
a nozzle plate positioned in an upper portion of the housing;
a plenum defined by the nozzle plate and a portion of the housing, the plenum receiving air from primary air from an air handler;
a nozzle plate comprising a plurality of apertures through which the primary air is expelled from the plenum, thereby causing an induction of air from an external setting into a lower portion of the housing;
an induction face positioned at a lower portion of the housing, the induction face being permeable to the air from the external setting;
a water coil positioned adjacent to the induction face within the housing, the water coil treating the air induced from the external setting;
a discharge channel positioned adjacent to the water coil within the lower portion of the housing, the primary air and the air induced from the external setting being expelled through the discharge channel into the external setting; and
a luminaire assembly positioned adjacent to the induction face and the discharge channel within the lower portion of the housing, the luminaire assembly comprising a luminaire that causes an illumination of the external setting.

12. The apparatus of claim 11, wherein the induction face comprises a grille, a plurality of perforations, or a plurality of louvers.

13. The apparatus of claim 11, wherein treating the air induced from the external setting comprises cooling or heating the primary air and the air induced from the external setting.

14. The apparatus of claim 11, wherein the water coil causes a cooling of air induced from the external setting that is undesirably heated by the luminaire.

15. The apparatus of claim 11, further comprising a control module configured to control an operation of the luminaire.

16. The apparatus of claim 15, wherein the control module is configured to wirelessly control the operation of the luminaire.

17. The apparatus of claim 11, wherein the luminaire assembly comprises a frame to which the luminaire is detachably attached.

18. The apparatus of claim 11, wherein the luminaire comprises an incandescent lamp, a fluorescent lamp, or a light-emitting diode lamp.

19. The apparatus of claim 11, wherein the apparatus is installed in a ceiling of the external setting.

20. The apparatus of claim 11, wherein the induction face comprises a pin latch configured to provide toolless access to internal components of the apparatus from the external setting.
